(19) United States
(12) Patent Application Publication
(10) Pub. No.: US 2010/0083151 A1
(43) Pub. Date: Apr. 1, 2010

(54) Natural language based filtering

(75) Inventors: Nathaniel Cleverly Lanza, Pittsburgh, PA (US); Christopher Douglas Weeldreyer, San Carlos, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/286,691

(22) Filed: Sep. 30, 2008

(51) Int. Cl. G06F 3/048

(52) U.S. Cl. 715/764

(57) ABSTRACT

Natural language based filtering is disclosed. In some embodiments, a user interface for defining one or more filters for a group of data allows one or more parameters associated with a filter definition, including a filter condition, to at least in part be specified in natural language. In some embodiments, a filter definition is specified at least in part by selecting one or more of a plurality of pre-configured natural language expressions made available for selection via the user interface.

### BACKGROUND OF THE INVENTION

Some existing spreadsheet applications support the specification of custom filters to filter a group or table of data in a desired manner. However, the specification of a filter in existing spreadsheet applications typically requires a user to be familiar with a special, programming-like syntax for specifying filter conditions and criteria. More elaborate filters require the specification of truth tables and formulas dependent on the truth tables.

### BRIEF DESCRIPTION OF THE DRAWINGS

Various embodiments of the invention are disclosed in the following detailed description and the accompanying drawings.

FIG. 1 illustrates an embodiment of a sort and filter user interface.

FIGS. 2A-B illustrate embodiments of specifying a filter.

FIGS. 2C-D illustrate an embodiment of specifying multiple filters.

FIGS. 3A-B illustrate embodiments of specifying a filter.

FIG. 4 illustrates an embodiment of specifying a date-based filter.

FIG. 5 illustrates an embodiment of a process for filtering a table.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “cell” refers to a cell associated with at least standard spreadsheet functionality. The term “at least standard spreadsheet functionality” in the context of a cell includes the ability to define the content of one cell in such a way that the content of the one cell is determined based at least in part on the content of one or more other cells, and the content of the one cell is updated automatically without further human action if the content of one or more of the one or more other cells is changed. As used herein, the term “host cell” refers to a cell in a formula editing mode, i.e., a cell into which a formula is being entered. In some embodiments, cells in a spreadsheet application are organized into one or more individual tables or table objects, each of which includes a desired number of rows and columns of cells. In such cases, a sheet or canvas of a spreadsheet document may include a desired number of table objects as well any desired number of other objects such as charts, graphs, images, etc. Although in some of the examples described herein the cells of a spreadsheet application are organized into such table objects, the techniques described herein may be similarly employed with respect to other cell configurations or organizations, such as the (seemingly) infinite single grid or table of cells in each sheet of some typical spreadsheet applications that includes an unlimited (or very large) number of rows and columns of cells. Although many of the examples provided herein are with respect to a spreadsheet application, the techniques described herein may be similarly employed with respect to any application, spreadsheet or otherwise.

Natural language based filtering is disclosed. In some embodiments, one or more parameters associated with a filter definition, including a filter condition, are at least in part specified in natural language, making the filter specification process a more user-friendly experience. In some embodiments, a (graphical) user interface that allows simple, natural language based constructs to be selected and/or specified for various parameters of a filter definition is provided and/or can be selected with respect to a group of data (e.g., a table of cells) for specifying one or more filters for sorting and/or filtering the rows and/or columns of the group of data.

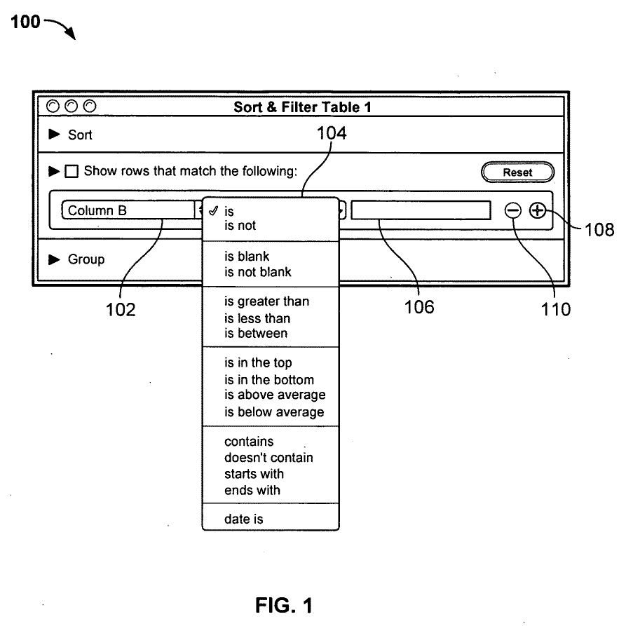

FIG. 1 illustrates an embodiment of a sort and filter user interface 100 provided with respect to a table (in this example named Table 1) that can be used to specify one or more filters to filter the rows of the table. As depicted, interface 100 includes a drop-down menu 102 with a list of columns of the table, a drop-down menu 104 with a list of conditions, and an input field 106. Drop-down menu 102 is used to select a column of the table (Column B of the table is selected in the given example) with respect to which to filter or sort the rows of the table. Drop-down menu 104 (which is expanded in the given example) is used to select a condition to be applied to the selected column. The conditions are at least in part expressed using natural language and in this example include Boolean phrases such as “is”, “is not”, “is blank”, “is not blank”, “is greater than”, “is less than”, “is between”, “is in the top”, “is in the bottom”, “is above average”, “is below average”, “contains”, “doesn't contain”, “starts with”, “ends with”, “date is”, etc. Input field 106 is provided for some conditions 104 for specifying a value and/or threshold for a selected condition. In some embodiments, another drop-down menu (not shown) to select a data type for input field 106 may be provided. In some embodiments, a data type for input field 106 does not have to be specified and is (automatically) inferred from the data type of the column 102 with respect to which the filter is being defined and/or the condition 104 selected. For some conditions, one or more drop-down menus of possible values may be provided instead of and/or in addition to input field 106, and in some cases, the values of such a drop-down menu may also be expressed using natural language constructs if applicable. The plus (+) button 108 may be employed to add another filter, and the minus (−) button 110 may be used to remove a filter. Although in the given example menus are provided for selecting a column and condition, in other embodiments, one or both of 102 and 104 may comprise input fields.

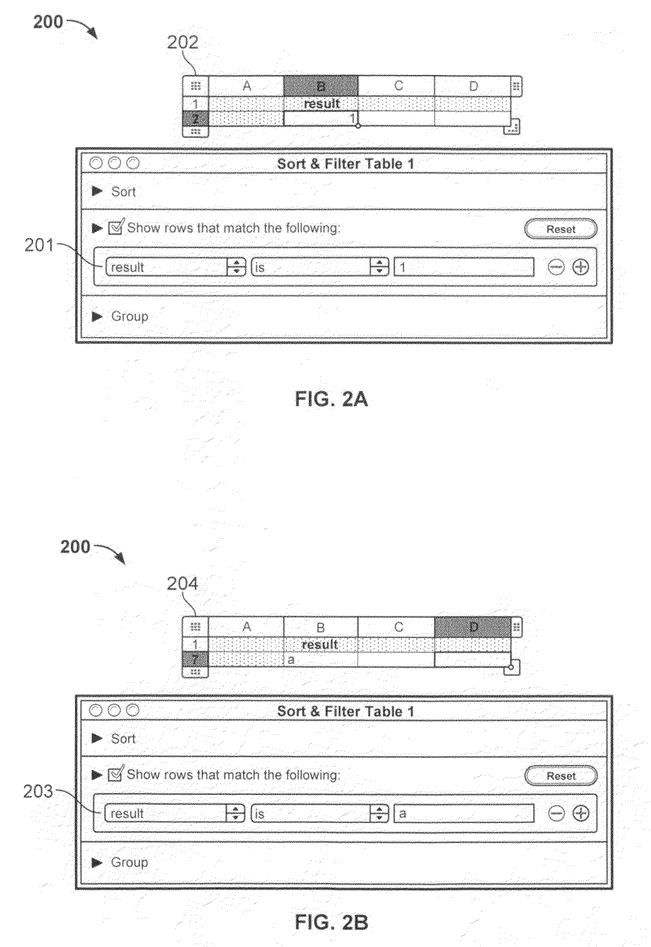

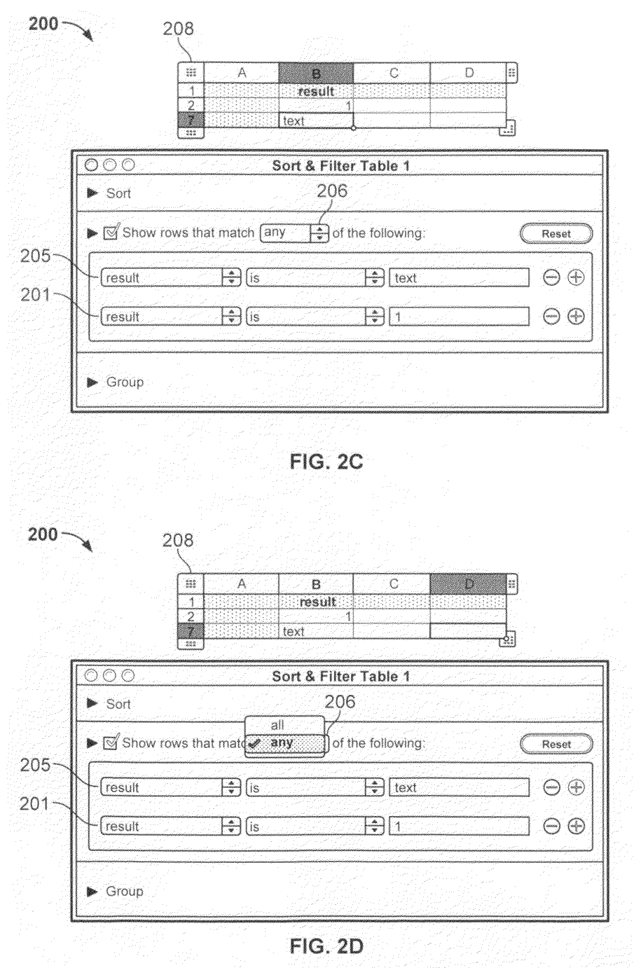

FIG. 2A and FIG. 2B illustrate embodiments of specifying a filter for a table (named Table 1) using an associated sort and filter user interface 200 and the resulting sorted and filtered versions of the table. In FIG. 2A, filter 201 filters the table to show each row whose “result” column “is” (i.e., has a value of) “1”. In the given example, only one row of the table has a value of “1” in its “result” column. This row is shown in the filtered version 202 of the table. In FIG. 2B, filter 203 filters the table to show each row whose “result” column “is” (i.e., has a value of) “a”. In the given example, only one row of the table has a value of “a” in its “result” column. This row is shown in the filtered version 204 of the table.

FIG. 2C and FIG. 2D illustrate an embodiment of specifying multiple filters for the table of FIG. 2A using sort and filter user interface 200 and the resulting sorted and filtered versions of the table. As depicted in FIG. 2C, another filter 205 in addition to the filter 201 specified in FIG. 2A is specified in interface 200. Filter 205 filters the table to show each row whose “result” column “is” (i.e., has a value of) the string “text”. When multiple filters are specified for a table, the rows of the table may be sorted to show rows that satisfy any (logical OR) of the filters or all (logical AND) of the filters. As depicted in FIGS. 2C and 2D, natural language values for the “any” and “all” options may be selected from drop-down menu 206. FIG. 2D illustrates the expansion of drop-down menu 206. The “any” option is selected in the example of FIGS. 2C and 2D, which results in the rows of the table that match or satisfy the condition of at least one of the filters 201 and 205 to be displayed. The filtered version 208 of the table shows only the rows of the table that have a value of “1” and/or “test” in their associated “result” column.

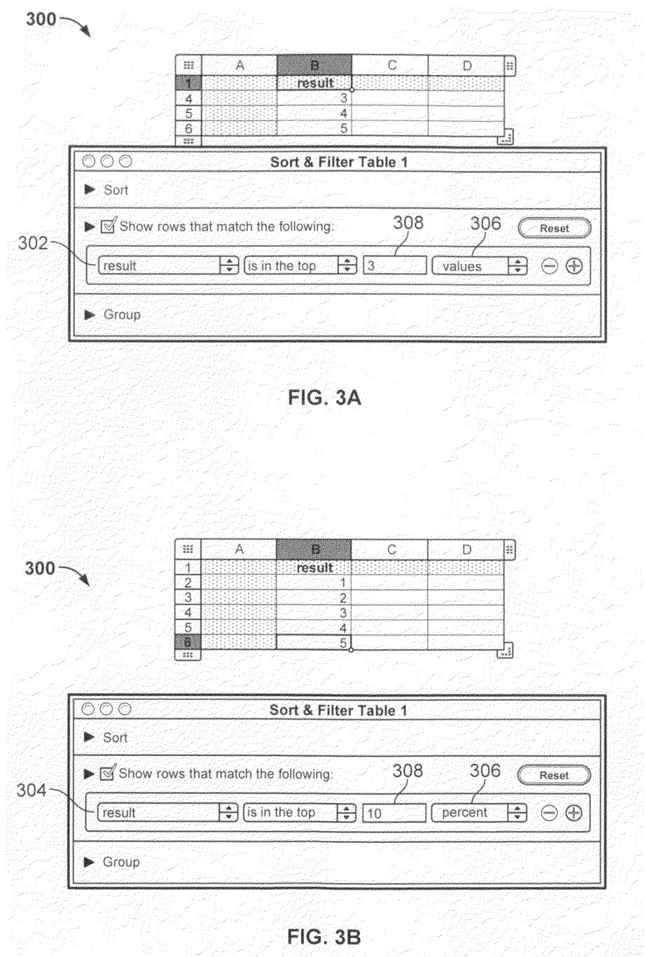

FIG. 3A and FIG. 3B illustrate embodiments of using the “is in the top” condition with a filter. In FIG. 3A, filter 302 filters a table to show the rows of the table that have the top three values in the “result” column. In FIG. 3B, filter 304 filters the table to show the rows of the table that have values in the top ten percent of the “result” column. As depicted in FIGS. 3A and 3B, user interface 300 provides a drop-down menu 306 to specify a type (e.g., values or percent in the given example) for the value of input field 308. The allowable types for a value associated with a condition may depend on the type of the condition.

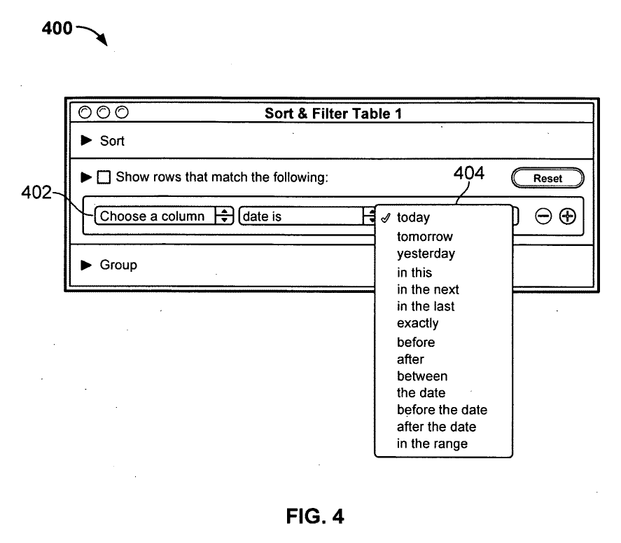

FIG. 4 illustrates an embodiment of specifying a date-based filter using sort and filter user interface 400. As depicted, the “date is” condition is selected for creating a date filter 402, and a drop-down menu 404 for selecting a relevant date range is provided for the “date is” condition. Date ranges may also at least in part be specified using natural language constructs such as “today”, “tomorrow”, “yesterday”, “in this”, “in the next”, “in the last”, “exactly”, “before”, “after”, “between”, “the date”, “before the date”, “after the date”, “in the range”, etc., as depicted in the given example.

Although FIGS. 1-4 illustrate various examples of specifying filters to filter the rows of a table, similar types of filters may be specified to filter the columns of a table. In such cases, for example, drop-down menu 102 of FIG. 1 provides a list of rows of the table.

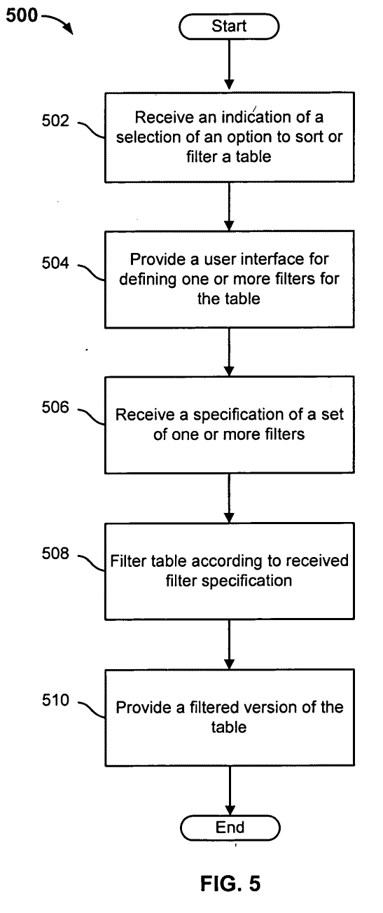

FIG. 5 illustrates an embodiment of a process 500 for filtering a table. Process 500 starts at 502 at which an indication of a selection of an option to sort or filter a table is received. At 504, a user interface for defining one or more filters for the table is provided. In some embodiments, the provided user interface is similar to those illustrated in FIGS. 1-4. In some embodiments, the user interface allows one or more parameters of a filter definition to at least in part be specified using natural language constructs. In various embodiments, a filter definition may include a specification of a column and/or row with respect to which the filter is to be applied, a specification of a condition, a specification of a value or threshold for a condition, a specification of a type of a value for a condition, etc. At 506, a specification of a set of one or more filters is received. In some embodiments, in the cases in which a plurality of filters is specified, 506 includes receiving a specification of which one or more filters (e.g., all or any) need to be satisfied for a match. At 508, the table is filtered according to the filter specification received at 506. At 510, a filtered version of the table is provided. Process 500 subsequently ends. In some embodiments, once one or more filters are applied to a table, they are persistently applied, until removed. In such cases, any subsequent changes in the data of the table results in an immediate reevaluation of the filter criteria.

The filter interface described herein allows complex filters to be created using a user-friendly, natural language based syntax for specifying a filter definition. Although some examples of a natural language based user interface have been described, in various embodiments, any appropriate user interface configuration may be employed that permits at least some parameters of a filter definition to be specified using natural language constructs.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer program product for processing a group of data, the computer program product being embodied in a computer readable storage medium and comprising computer instructions for:
providing a user interface for defining one or more filters for a group of data;
wherein the user interface allows one or more parameters associated with a filter definition, including a filter condition, to be specified at least in part in natural language.

2. The computer program product recited in claim 1, wherein a filter definition comprises a specification of a column of the group of data with respect to which one or more rows of the group of data are to be filtered.

3. The computer program product recited in claim 1, wherein a filter definition comprises a specification of a row of the group of data with respect to which one or more columns of the group of data are to be filtered.

4. The computer program product recited in claim 1, wherein a filter definition comprises one or more of a specification of a condition, a specification of a value for a condition, and a specification of a type of a value for a condition.

5. The computer program product recited in claim 1, wherein a filter definition is specified at least in part by selecting one or more of a plurality of pre-configured natural language expressions made available for selection via the user interface.

6. The computer program product recited in claim 1, wherein the user interface comprises one or more of: a menu for selecting a row of the group of data, a menu for selecting a column of the group of data, a menu for selecting a filter condition, an input field for specifying a value for a filter condition, a menu for selecting a value for a filter condition, and a menu for selecting a data type of a value for a filter condition.

7. The computer program product recited in claim 1, wherein at least a portion of a filter condition comprises one or more of: “is”, “is not”, “is blank”, “is not blank”, “is greater than”, “is less than”, “is between”, “is in the top”, “is in the bottom”, “is above average”, “is below average”, “contains”, “doesn't contain”, “starts with”, “ends with” and “date is”.

8. The computer program product recited in claim 1, wherein the user interface provides an option to define a date-based filter.

9. The computer program product recited in claim 8, wherein the user interface allows a date range associated with a date-based filtered to at least in part be specified in natural language.

10. A system for processing a group of data, comprising:
a processor configured to:
provide a user interface for defining one or more filters for a group of data, wherein the user interface allows one or more parameters associated with a filter definition, including a filter condition, to be specified at least in part in natural language; and
a memory coupled to the processor and configured to provide the processor with instructions.

11. The system recited in claim 10, wherein a filter definition comprises one or more of a specification of a condition, a specification of a value for a condition, and a specification of a type of a value for a condition.

12. The system recited in claim 10, wherein a filter definition is specified at least in part by selecting one or more of a plurality of pre-configured natural language expressions made available for selection via the user interface.

13. The system recited in claim 10, wherein the user interface comprises one or more of: a menu for selecting a row of the group of data, a menu for selecting a column of the group of data, a menu for selecting a filter condition, an input field for specifying a value for a filter condition, a menu for selecting a value for a filter condition, and a menu for selecting a data type of a value for a filter condition.

14. The system recited in claim 10, wherein the user interface provides an option to define a date-based filter.

15. The system recited in claim 14, wherein the user interface allows a date range associated with a date-based filtered to at least in part be specified in natural language.

16. A method for processing a group of data, comprising:
providing a user interface for defining one or more filters for a group of data;
wherein the user interface allows one or more parameters associated with a filter definition, including a filter condition, to be specified at least in part in natural language.

17. The method recited in claim 16, wherein a filter definition comprises one or more of a specification of a condition, a specification of a value for a condition, and a specification of a type of a value for a condition.

18. The method recited in claim 16, wherein a filter definition is specified at least in part by selecting one or more of a plurality of pre-configured natural language expressions made available for selection via the user interface.

19. The method recited in claim 16, wherein the user interface provides an option to define a date-based filter.

20. The method recited in claim 19, wherein the user interface allows a date range associated with a date-based filtered to at least in part be specified in natural language.
